(19) United States
(12) Patent Application Publication
(10) Pub. No.: US 2025/0129654 A1
(43) Pub. Date: Apr. 24, 2025

(54) POWERED DOOR UNIT OPTIMIZED FOR SERVO CONTROL

(71) Applicant: MAGNA CLOSURES INC., Newmarket (CA)

(72) Inventors: Francesco CUMBO, Newmarket (CA); Sandro BERTINI, Newmarket (CA); Yufei LU, Newmarket (CA)

(21) Appl. No.: 18/907,469

(22) Filed: Oct. 4, 2024

Related U.S. Application Data
(60) Provisional application No. 63/545,048, filed on Oct. 20, 2023.

(51) Int. Cl. E05F 15/622; E05F 5/02

(52) U.S. Cl. CPC E05F 15/622; E05F 5/025; E05Y 2201/21; E05Y 2201/258; E05Y 2201/70; E05Y 2201/702; E05Y 2201/704; E05Y 2900/531

(57) ABSTRACT

A powered actuator includes a leadscrew as an extensible member connected to a closure, such as a vehicle side door and is configured to move linearly for opening or closing the closure. The first powered actuator also includes a gearbox configured apply a force to the extensible member for causing the extensible member to move linearly. An adapter is configured to mount the gearbox to the vehicle body. The adapter allows the powered actuator to replace a non-powered door check device. The adapter also allows some relative rotation between the gearbox and the vehicle body for fitment of the powered actuator. An electromagnetic (EM) brake is coupled to the gearbox on an opposite side from the electric motor. A high-resolution position sensor is coupled to a driven shaft to measure a position of the actuator, the position sensor is spaced apart from the EM brake to prevent electromagnetic interference therefrom.

### CROSS-REFERENCE TO RELATED APPLICATION

This application claims the benefit of U.S. Provisional Application Ser. No. 63/545,048, filed Oct. 20, 2023, which is incorporated herein by reference in its entirety.

### FIELD

The present disclosure relates to a power actuator for a vehicle closure. More specifically, the present disclosure relates to a power actuator assembly for a vehicle side door having a brake device.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define a pivot axis. Such swinging passenger doors (“swing doors”) may be moveable by power closure member actuation systems. Specifically, the power closure member system can function to automatically swing the passenger door about its pivot axis between the open and closed positions, to assist the user as he or she moves the passenger door, and/or to automatically move the passenger door in between closed and open positions for the user.

Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Scheuring et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

A high-resolution position sensor, such as a magnet wheel and a Hall effect sensor, may be used to accurately measure a position in a power closure actuation sensor. However, such high-resolution sensors can be adversely affected by electromagnetic (EM) interference, such as may be generated by an EM brake.

In view of the above, there remains a need to develop power closure member actuation systems which address and overcome limitations and drawbacks associated with known power closure member actuation systems as well as to provide increased convenience and enhanced operational capabilities.

### SUMMARY

This section provides a general summary of the disclosure, and is not a comprehensive disclosure of its full scope or all of its features.

It is an objective of the present disclosure to provide a powered actuator for a closure of a vehicle having an electric motor configured to rotate a driven shaft, an extensible member configured to be coupled to one of a body or the closure of the vehicle for opening or closing the closure, a gear reduction mechanism configured apply a force to the extensible member for causing the extensible member to extend and retract in response to rotation of the driven shaft, and a brake mechanism coupled to the motor drive shaft to apply a braking force on the driven shaft.

In a related aspect, the brake mechanism is indirectly coupled to the driven shaft.

In a related aspect, the brake mechanism is coupled to the driven shaft using a gear reduction mechanism.

In a related aspect, the gear reduction mechanism is selected from the group consisting of: a gear coupling, a toothed belt coupling; and a belt coupling.

In a related aspect, the gear reduction mechanism is configured to multiply a braking force of the brake mechanism applied to the driven shaft.

In a related aspect, the brake mechanism is coupled to the \ driven shaft using a gear reduction mechanism.

In a related aspect, the brake mechanism comprises a magnetic brake.

In a related aspect, the magnetic brake is a hysteresis brake having a stationary component and a rotatable component.

In a related aspect, the driven shaft is configured to extend along a driven shaft axis and the brake mechanism comprises a brake axis disposed parallel and adjacent to the driven shaft axis.

In a related aspect, the driven shaft comprises a first gear, and the brake mechanism comprises a brake shaft supporting a second gear, wherein the first gear is in meshed engagement with the second gear.

In a related aspect, the driven shaft is configured to support a worm gear, the worm gear configured to rotate a worm wheel, the worm wheel configured to move the extensible member.

In a related aspect, the worm gear is positioned between the first gear and the electric motor.

In a related aspect, the extensible member comprises a leadscrew configured to move axially in response to rotation of a lead nut; and wherein the worm wheel is coupled to rotate the lead nut.

In a related aspect, the extensible member comprises linkage coupled to a leads nut moveable in response to rotation of a lead screw, the extensible member configured to move axially in response to rotation of the lead nut; and wherein the driven shaft is adapted to rotate the lead screw.

It is a further objective of the present disclosure to provide a powered actuator for a closure of a vehicle including an electric motor configured to rotate a driven shaft, a worm coupled to the driven shaft, a gear coupled to the worm, an extensible member coupled to the gear, the extensible member configured to be coupled to one of a body or the closure of the vehicle for opening or closing the closure, wherein the extensible member is configured to extend and retract in response to rotation of the gear, a brake mechanism coupled to the driven shaft, the brake mechanism having a hysteresis magnet, and a gear reduction mechanism operatively coupling the driven shaft to the brake mechanism, wherein the brake mechanism comprises a brake axis that is disposed parallel to an axis of the driven shaft.

It is a further objective of the present disclosure to provide a method of braking a powered actuator for a closure of a vehicle comprising an electric motor configured to rotate a driven shaft to extend and retract an extensible member, the method comprising providing a brake mechanism, coupling the brake mechanism to the driven shaft using a gear reduction mechanism, and configuring the torque multiplication mechanism to multiply the brake force of the brake mechanism to be applied by the gear reduction mechanism to the driven shaft.

In a related aspect, the method may include arranging an axis of the brake mechanism to be parallel with the axis of the driven shaft.

In a related aspect, the method may include providing the gear reduction mechanism having meshed gears.

In a related aspect, the method may include configuring the brake mechanism having a hysteresis magnet.

In a related aspect, the method may include configuring the brake mechanism having a hysteresis magnet.

### DRAWINGS

The drawings described herein are for illustrative purposes only of selected embodiments and not all possible implementations, and are not intended to limit the scope of the present disclosure.

FIG. 1 is a perspective view of an example motor vehicle equipped with a power closure member actuation system situated between the front passenger swing door and a vehicle body, according to aspects of the disclosure;

FIG. 2 is a perspective inner side view of a closure member shown in FIG. 1, with various components removed for clarity purposes only, in relation to a portion of the vehicle body and which is equipped with the power closure member actuation system, according to aspects of the disclosure;

FIG. 3 illustrates a block diagram of the power closure member actuation system, according to aspects of the disclosure;

FIG. 4 illustrates another block diagram of the power closure member actuation system for moving the closure member in an automatic mode, according to aspects of the disclosure;

FIG. 5 illustrates the power closure member actuation system shown as part of a vehicle system architecture, according to aspects of the disclosure;

FIG. 6 illustrates another block diagram of the power closure member actuation system for moving the closure member in a powered assist mode, according to aspects of the disclosure;

FIG. 7 illustrates a first powered actuator according to aspects of the disclosure;

FIG. 8 illustrates a second powered actuator according to aspects of the disclosure;

FIG. 9 illustrates the first powered actuator of FIG. 7, according to aspects of the disclosure;

FIG. 10 illustrates a non-powered door check device;

FIG. 11A illustrates a powered actuator protruding from an internal cavity of a passenger door according to aspects of the disclosure;

FIG. 11B illustrates the powered actuator of FIG. 11A disposed within the internal cavity of the passenger door;

FIG. 12A illustrates the first powered actuator according to aspects of the disclosure;

FIG. 12B illustrates an exploded view of components within the first powered actuator according to aspects of the disclosure;

FIG. 13A illustrates a partial cut-away view of the first powered actuator according to aspects of the disclosure;

FIG. 13B illustrates cut-away view of an EM brake of the powered actuator according to aspects of the disclosure;

FIG. 14 illustrates a cut-away view of a third powered actuator according to aspects of the disclosure;

FIG. 15 illustrates a cut-away view of a fourth powered actuator according to aspects of the disclosure;

FIG. 16A illustrates an exploded perspective view of a motor and coupling of a fifth powered actuator according to aspects of the disclosure;

FIG. 16B illustrates a perspective view of the motor and a partial drive assembly within the fifth powered actuator according to aspects of the disclosure;

FIG. 16C illustrates a slip device of the coupling of the fifth powered actuator according to aspects of the disclosure;

FIG. 17 illustrates a perspective view of a motor and a partial drive assembly within a sixth powered actuator according to aspects of the disclosure;

FIG. 18 illustrates a cut-away perspective view of a motor and a partial drive assembly within a seventh powered actuator according to aspects of the disclosure;

FIG. 19 illustrates a cut-away perspective view of an eighth powered actuator according to aspects of the disclosure;

FIG. 20 illustrates a schematic block diagram of components within a powered actuator in a first configuration according to aspects of the disclosure;

FIG. 21 illustrates a schematic block diagram of components within a powered actuator in a second configuration according to aspects of the disclosure;

FIG. 22 illustrates a schematic block diagram of components within a powered actuator in a third configuration according to aspects of the disclosure;

FIG. 23 illustrates a schematic block diagram of components within a powered actuator in a fourth configuration according to aspects of the disclosure;

FIG. 23A illustrates a schematic block diagram of components within a powered actuator in a fifth configuration according to aspects of the disclosure;

FIG. 24 illustrates a perspective view of a ninth powered actuator according to aspects of the disclosure;

FIG. 25A illustrates a perspective view of the ninth powered actuator with a telescoping boot in an expanded state according to aspects of the disclosure;

FIG. 25B illustrates a perspective view of the ninth powered actuator with a telescoping boot in a retracted state according to aspects of the disclosure;

FIG. 26 illustrates a schematic block diagram of components within a powered actuator of the prior art;

FIG. 27 illustrates a schematic block diagram of components within a powered actuator according to aspects of the disclosure;

FIG. 28 illustrates a top perspective view of the tenth powered actuator with a extensible linkage according to aspects of the disclosure;

FIG. 29 illustrates a bottom perspective view of the tenth powered actuator of FIG. 28 illustrating a positioned of a brake mechanism on the bottom side of the powered actuator;

FIG. 30 illustrates a partial enlarged bottom perspective view of the tenth powered actuator of FIG. 29 having a partial transparency of the powered actuator housing illustrating a torque multiplication coupling of a brake mechanism to a motor shaft, in accordance with aspects of the present disclosure;

FIG. 31 illustrates a cross sectional view of the tenth powered actuator of FIG. 28 illustrating a positioned of a brake mechanism having an axis offset from the motor shaft axis, in accordance with aspects of the disclosure;

FIG. 32 illustrates an enlarged cross-sectional view of FIG. 31, in accordance with aspects of the present disclosure;

FIG. 33 illustrates an enlarged cross-sectional view of FIG. 28, illustrating another embodiment of a brake mechanism coupled to a distal end of the lead screw of the tenth powered actuator, in accordance with aspects of the present disclosure; and

FIG. 34 illustrates an exploded view of another embodiment of a brake mechanism for coupling to a proximal end of the lead screw of the tenth powered actuator, in accordance with aspects of the present disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

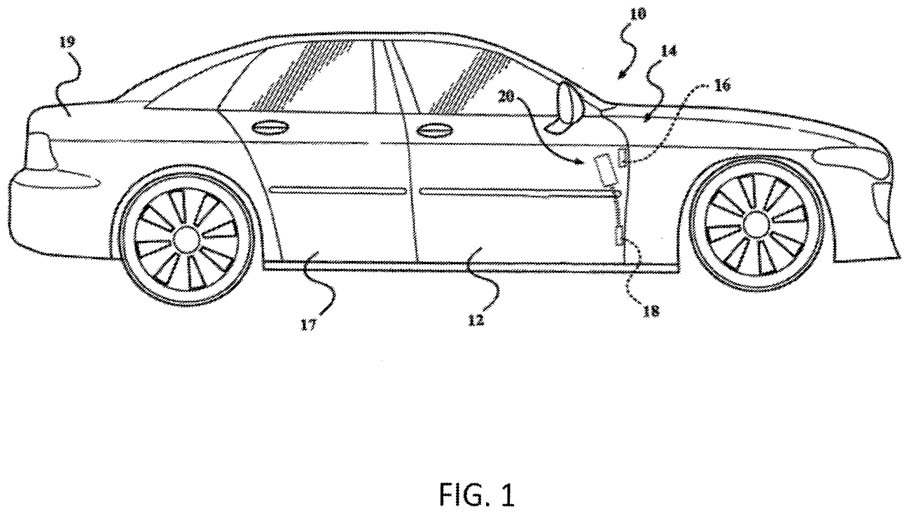

Referring initially to FIG. 1, an example motor vehicle 10 is shown to include a first passenger door 12 pivotally mounted to a vehicle body 14 via an upper door hinge 16 and a lower door hinge 18 which are shown in phantom lines. In accordance with the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system can also be associated with any other closure member (e.g., door or liftgate) of vehicle 10 such as rear passenger doors 17 and decklid 19.

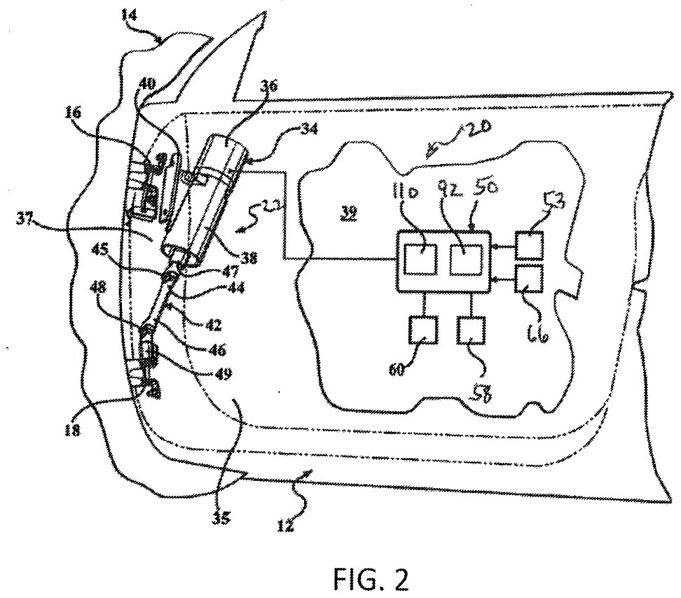

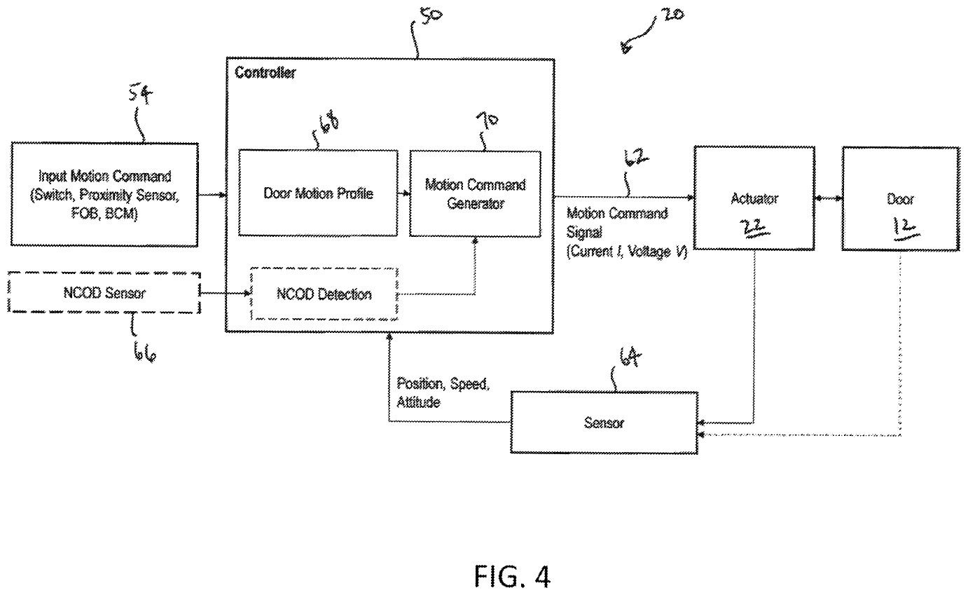

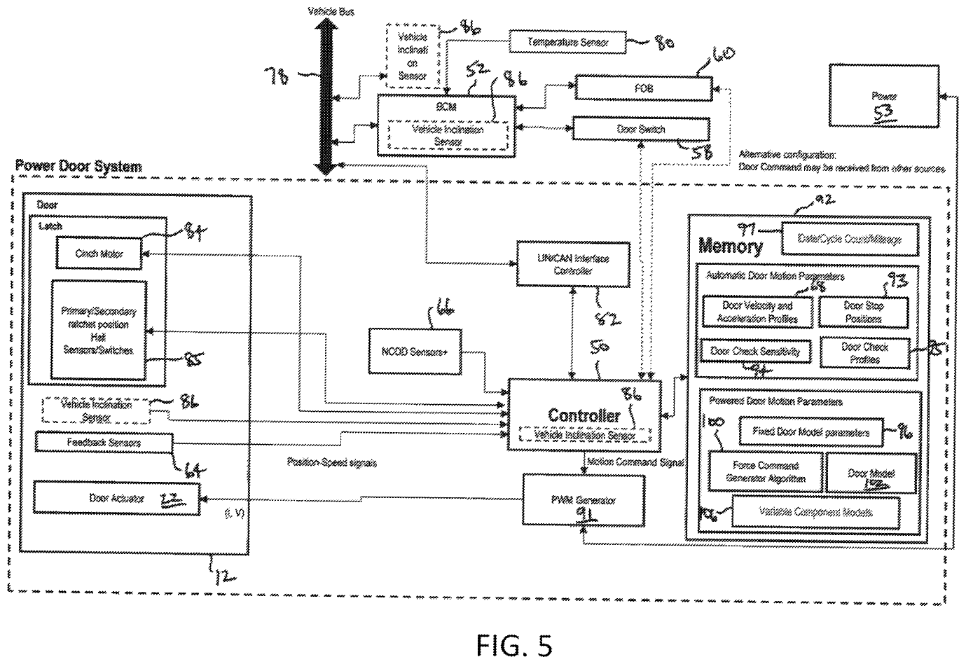

Power closure member actuation system 20 is generally shown in FIG. 2 and, as mentioned, is operable for controllably pivoting vehicle door 12 relative to vehicle body 14 between an open position and a closed position. As shown in FIGS. 4 and 5, lower hinge 18 of power closure member actuation system 20 includes a door hinge strap 28 connected to vehicle door 12 and a body hinge strap 30 connected to vehicle body 14. Door hinge strap 28 and body hinge strap 30 of lower door hinge 18 are interconnected along a generally vertically-aligned pivot axis A via a hinge pin 32 to establish the pivotable interconnection between door hinge strap 28 and body hinge strap 30. However, any other mechanism or device can be used to establish the pivotable interconnection between door hinge strap 28 and body hinge strap 30 without departing from the scope of the subject disclosure.

As best shown in FIG. 2, power closure member actuation system 20 includes a power-operated actuator mechanism 22 having a motor and geartrain assembly 34 that is rigidly connectable to vehicle door 12. Motor and geartrain assembly 34 is configured to generate a rotational force. In the preferred embodiment, motor and geartrain assembly 34 includes an electric motor 36 that is operatively coupled to a speed reducing/torque multiplying assembly, such as a high gear ratio planetary gearbox 38. The high gear ratio planetary gearbox 38 may include multiple stages, thus allowing motor and geartrain assembly 34 to generate a rotational force having a high torque output by way of a very low rotational speed of electric motor 36. However, any other arrangement of motor and geartrain assembly 34 can be used to establish the required rotational force without departing from the scope of the subject disclosure.

Motor and geartrain assembly 34 includes a mounting bracket 40 for establishing the connectable relationship with vehicle door 12. Mounting bracket 40 is configured to be connectable to vehicle door 12 adjacent to the door-mounted door hinge strap associated with upper door hinge 16. As further shown in FIG. 2, this mounting of motor assembly 34 adjacent to upper door hinge 16 of vehicle door 12 disposes the power-operated actuator mechanism 22 of power closure member actuation system 20 in close proximity to the pivot axis A. The mounting of motor and geartrain assembly 34 adjacent to upper door hinge 16 of vehicle door 12 minimizes the effect that power closure member actuation system 20 may have on a mass moment of inertia (i.e., pivot axis A) of vehicle door 12, thus improving or easing movement of vehicle door 12 between its open and closed positions. In addition, as also shown in FIG. 2, the mounting of motor and geartrain assembly 34 adjacent to upper door hinge 16 of vehicle door 12 allows power closure member actuation system 20 to be packaged in front of an A-pillar glass run channel 35 associated with vehicle door 12 and thus avoids any interference with a glass window function of vehicle door 12. Put another way, power closure member actuation system 20 can be packaged in a portion 37 of an internal door cavity 39 within vehicle door 12 that is not being used, and therefore reduces or eliminates impingement on existing hardware/mechanisms within vehicle door 12. Although power closure member actuation system 20 is illustrated as being mounted adjacent to upper door hinge 16 of vehicle door 12, power closure member actuation system 20 can, as an alternative, also be mounted elsewhere within vehicle door 12 or even on vehicle body 14 without departing from the scope of the subject disclosure.

Power closure member actuation system 20 further includes a rotary drive mechanism that is rotatively driven by the power-operated actuator mechanism 22. As shown in FIG. 2, the rotary drive mechanism includes a drive shaft 42 interconnected to an output member of gearbox 38 of motor and geartrain assembly 34 and which extends from a first end 44 disposed adjacent gearbox 38 to a second end 46. The rotary output component of motor and geartrain assembly 34 can include a first adapter 47, such as a square female socket or the like, for drivingly interconnecting first end 44 of drive shaft 42 directly to the rotary output of gearbox 38 In addition, although not expressly shown, a disconnect clutch can be disposed between the rotary output of gearbox 38 and first end 44 of drive shaft 42. In one configuration, the clutch would normally be engaged without power (i.e., power-off engagement) and could be selectively energized (i.e., power-on release) to disengage. Put another way, the optional clutch drivingly would couple drive shaft 42 to motor and geartrain assembly 34 without the application of electrical power while the clutch would require the application of electrical power to uncouple drive shaft 42 from driven connection with gearbox 38. As an alternative, the clutch could be configured in a power-on engagement and power-off release arrangement. The clutch may engage and disengage using any suitable type of clutching mechanism such as, for example, a set of sprags, rollers, a wrap-spring, friction plates, or any other suitable mechanism. The clutch is provided to permit door 12 to be manually moved by the user between its open and closed positions relative to vehicle body 14. Such a disconnect clutch could, for example, be located between the output of electric motor 36 and the input to gearbox 38. The location of this optional clutch may be dependent based on, among other things, whether or not gearbox 38 includes “back-drivable” gearing.

Second end 46 of drive shaft 42 is coupled to body hinge strap 30 of lower door hinge 18 for directly transferring the rotational force from motor and geartrain assembly 34 to door 12 via body hinge strap 30. To accommodate angular motion due to swinging movement of door 12 relative to vehicle body 14, the rotary drive mechanism further includes a first universal joint or U-joint 45 disposed between first adapter 47 and first end 44 of drive shaft 42 and a second universal joint or U-joint 48 disposed between a second adapter 49 and second end 46 of drive shaft 42. Alternatively, constant velocity joints could be used in place of the U-joints 45, 48. The second adapter 49 may also be a square female socket or the like configured for rigid attachment to body hinge strap 30 of lower door hinge 18. However, other means of establishing the drive attachment can be used without departing from the scope of the disclosure. Rotation of drive shaft 42 via operation of motor and geartrain assembly 34 functions to actuate lower door hinge 18 by rotating body hinge strap 30 about its pivot axis to which drive shaft 42 is attached and relative to door hinge strap 28. As a result, power closure member actuation system 20 is able to effectuate movement of vehicle door 12 between its open and closed positions by “directly” transferring a rotational force directly to body hinge strap 30 of lower door hinge 18. With motor and geartrain assembly 34 connected to vehicle door 12 adjacent to upper door hinge 16, second end 46 of drive shaft 42 is attached to body hinge strap 30 of lower door hinge 18. Based on available space within door cavity 39, it may be possible to mount motor and geartrain assembly 34 adjacent to the door-mounted hinge component of lower door hinge 18 and directly connect second end 46 of drive shaft 42 to the vehicle-mounted hinge component of upper door hinge 16. In the alternative, if motor and geartrain assembly 34 is connected to vehicle body 14, second end 46 of drive shaft 42 would be attached to door hinge strap 28.

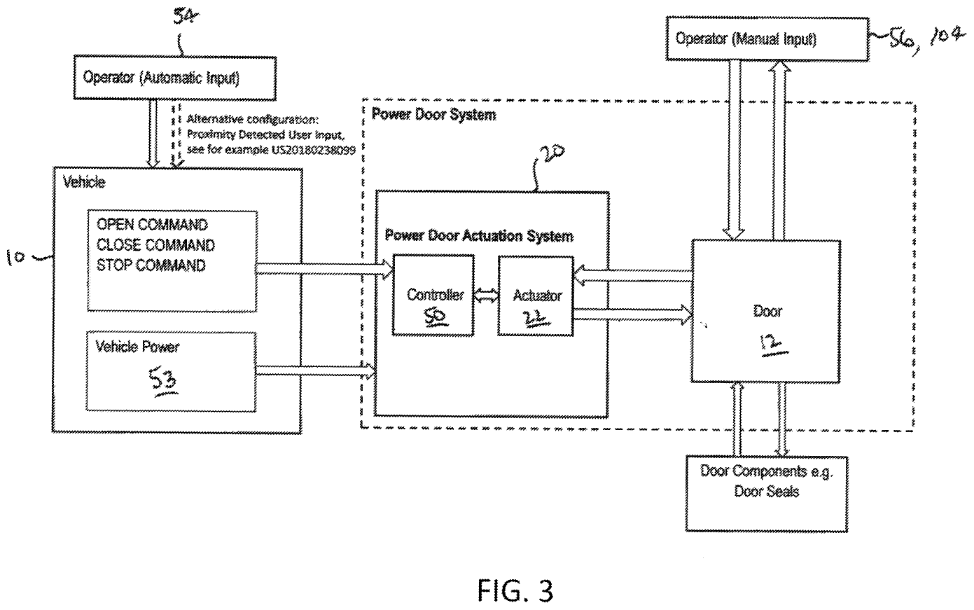

FIG. 3 illustrates a block diagram of the power closure member actuation system 20 for moving the closure member (e.g., vehicle door 12 or 17) of the vehicle 10 in between open and closed positions relative to the vehicle body 14. As discussed above, the power closure member actuation system 20 includes the actuator 22 that is coupled to the closure member (e.g., vehicle door 12) and the vehicle body 14. The actuator 22 is configured to move the closure member 12 relative to the vehicle body 14. The power closure member actuation system 20 also includes a controller 50 that is coupled to the actuator 22 and in communication with other vehicle systems (e.g., a body control module 52) and also receives vehicle power from the vehicle 10 (e.g., from a vehicle battery 53, shown in FIG. 5). The controller 50 is operable in at least one of an automatic mode (in response to an automatic mode initiation input 54) and a powered assist mode (in response to a motion input 56). In the automatic mode, the controller 50 commands movement of the closure member through a predetermined motion profile (e.g., to open the closure member). The powered assist mode is different than the automatic mode in that the motion input 56 from the user may be continuous to move the closure member, as opposed to a singular input by the user in automatic mode. Commands from the other vehicle systems may, for example, include instructions the controller 50 to open the closure member, close the closure member, or stop motion of the closure member (e.g., in the automatic mode). Also shown are other components that may have an impact on the operation of the power closure member actuation system 20, such as door seals of the vehicle door 12, for example.

Referring now to FIG. 4, the controller 50 is configured to receive the automatic mode initiation input 54 and enter the automatic mode to output a motion command 62 in response to receiving the automatic mode initiation input 54. The automatic mode initiation input 54 can be a manual input on the closure member itself or an indirect input to the vehicle 10 (e.g., closure member switch 58 on the closure member, switch on a key fob 60, etc.). So, the automatic mode initiation input 54 may, for example, be a result of a user or operator operating a switch (e.g., the closure member switch 58), making a gesture near the vehicle 10, or possessing a key fob 60 near the vehicle 10. It should also be appreciated that other automatic mode initiation inputs 54 are contemplated, such as, but not limited to a proximity of the user detected by a proximity sensor.

In addition, the power closure member actuation system 20 includes at least one closure member feedback sensor 64 for determining at least one of a position and a speed of the closure member. Thus, the at least one closure member feedback sensor 64 detects signals from either the actuator 22 by counting revolutions of the electric motor 36, absolute position of an extensible member (not shown), or from the door 12 (e.g., an absolute position sensor on a door check as an example) can provide position information to the controller 50.

The power closure member actuation system 20 additionally includes at least one non-contact obstacle detection sensor 66 coupled to the controller 50. The controller 50 is configured to determine whether an obstacle is detected using the at least one non-contact obstacle detection sensor 66 and may, for example, cease movement of the closure member in response to determining that the obstacle is detected. The at least one non-contact obstacle detection sensor 66 and operation of the proximity sensor are discussed in U.S. Publication No. 2018/0238099, incorporated herein by reference.

In the automatic mode, the controller 50 can include one or more closure member motion profiles 68 that are utilized by the controller 50 when generating the motion command 62 (e.g., using a motion command generator 70 of the controller 50) in view of the obstacle detection by the at least one non-contact obstacle detection sensor 66. So, in the automatic mode, the motion command 62 has a specified motion profile 68 (e.g., acceleration curve, velocity curve, deceleration curve, and stop position) so as to control the movement of the closure member in a predetermined manner, for example, by controlling the movement of the closure member at a constant speed.

In FIG. 5, the power closure member actuation system 20 is shown as part of a vehicle system architecture 72 operable in the automatic mode and the powered assist mode. The body control module 52 is in communication with the controller 50 via a vehicle bus 78 (e.g., a Local Interconnect Network or LIN bus). The body control module 52 can also be in communication with the key fob 60 (e.g., wirelessly) and a closure member switch 58 configured to output a closure member trigger signal through the body control module 52. Alternatively, the closure member switch 58 could be connected directly to the controller 50 or otherwise communicated to the controller 50. The body control module 52 may also be in communication with at least one environmental sensor 80. Specifically, the at least one environmental sensor can be a temperature sensor 80.

The controller 50 can be coupled to a closure communications interface control unit 82 which connects to the vehicle bus 78. In other words, the closure communication interface control unit 82 facilitates communication between the controller 50 and the vehicle bus 78. The controller is also coupled with a latch 83 that includes a cinch motor 84 (for cinching the closure member 12 into the closed position). The latch 83 also includes a plurality of primary and secondary ratchet position sensors or switches 85 that provide feedback to the controller 50 regarding whether the latch 83 is in a latch primary position or a latch secondary position, for example.

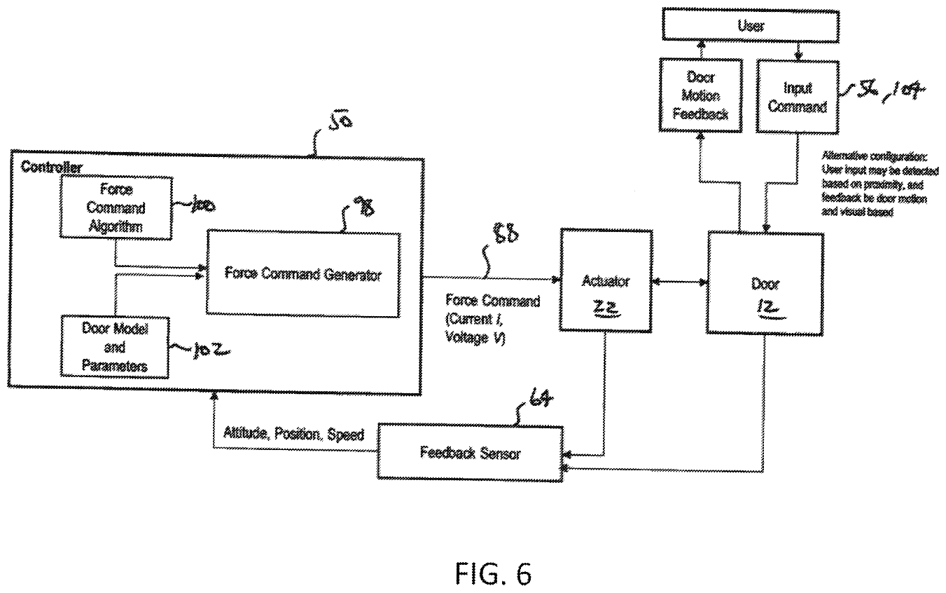

A vehicle inclination sensor 86 (such as an accelerometer) is also coupled to the controller 50 for detecting an inclination of the vehicle 10. The vehicle inclination sensor 86 outputs an inclination signal corresponding to the inclination of the vehicle 10 and the controller 50 is further configured to receive the inclination signal and adjust the one of a force command 88 (FIG. 6) and the motion command 62 accordingly. While the vehicle inclination sensor 86 may be separate from the controller 50, it should be understood that the vehicle inclination sensor 86 may also be integrated in the controller 50, in the closure member (e.g., door 12 or 17), or in another control module, such as, but not limited to the body control module 52.

A pulse width modulation unit 91 is also coupled to the controller 50 and is configured to receive a pulse width control signal and output an actuator command signal corresponding to the pulse width control signal. The controller 50 includes a processor or other computing unit 110 in communication with the memory device 92. So, the controller 50 is coupled to a memory device 92 for storing a plurality of automatic closure member motion parameters 68, 93, 94, 95 for the automatic mode and a plurality of powered closure member motion parameters 96, 100, 102, 106 for the powered assist mode and used by the controller 50 for controlling the movement of the closure member (e.g., door 12 or 17). Specifically, the plurality of automatic closure member motion parameters 68, 93, 94, 95 includes at least one of closure member motion profiles 68 (e.g., plurality of closure member velocity and acceleration profiles), a plurality of closure member stop positions 93 (e.g., see FIG. 9), a closure member check sensitivity 94, and a plurality of closure member check profiles 95. The plurality of powered closure member motion parameters 96, 100, 102, 106 includes at least one of a plurality of fixed closure member model parameters 96 and a force command generator algorithm 100 and a closure member model 102 and a plurality of closure member component profiles 106. In addition, the memory device 92 stores a date and mileage and cycle count 97. The memory device 92 may also store boundary conditions (e.g., plurality of predetermined operating limits) used for a boundary check to prevent movement of the closure member and operation of the actuator 22 outside a plurality of predetermined operating limits or boundary conditions.

As best shown in FIG. 6, the controller 50 is also configured to receive the motion input 56 and enter the powered assist mode to output the force command 88 (e.g., using a force command generator 98 of the controller 50 as a function of the force command algorithm 101, closure member model 102, and plurality of closure member component profiles 106). The controller 50 is also configured to generate the force command 88 using the at least one environmental condition to control an actuator output force acting on the closure member to move the closure member. So, the controller 50 varies an actuator output force acting on the closure member to move the closure member in response to receiving the motion input 56. In the powered assist mode, the force command 88 has a specified force profile (e.g., that may be altered to based on changes in the environmental condition, such as by increasing or decreasing the force assist provided to the user). A user movement sensor 104 is coupled to the controller 50 and is configured to sense the motion input 56 from the user on the closure member to move the closure member. Again, the power closure member actuation system 20 further includes at least one closure member feedback sensor 64 for determining at least one of a position and speed of the closure member. The at least one closure member feedback sensor 64 detects the position and/or speed of the closure member, as described above for the automatic mode, and can provide corresponding position/motion information or signals to the controller 50 concerning how the user is interacting with the closure member during powered assist mode. For example, the at least one closure member feedback sensor 64 determine how fast the user is moving the closure member (e.g., door 12 or 17). The attitude or inclination sensor 86 may also determine the angle or inclination of the closure member and the power closure member actuation system 20 may compensate for such an angle to assist the user and negate any effects on the closure member motion that the change in angle causes (e.g., for example changes regarding how gravity may influence the closure member differently based on the angle of the closure member relative to a ground plane).

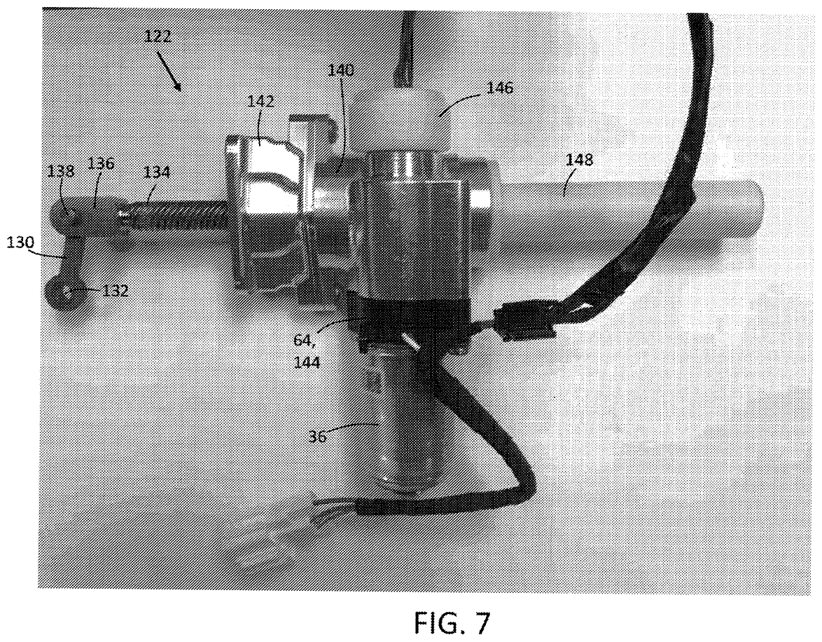

Referring now to FIG. 7, a first powered actuator 122 is disclosed. The first powered actuator 122 includes a link bar 130 defining a distal hole 132. The distal hole 132 is configured to be connected to the vehicle body 14 in some embodiments where the first powered actuator 122 is disposed within the closure, for example as shown in FIG. 2. Alternatively, the distal hole 132 may be configured to be connected to the closure, such as a vehicle side door 12, 17 in embodiments where the first powered actuator is disposed outside of the closure, for example within a structure of the vehicle body 14. The link bar 130 is connected to an extensible member 134 via a linkage 136 having a pin 138 pivotably supporting the link bar 130. Thus, the extensible member 134 is configured to be coupled to the vehicle body 14 or the closure of the vehicle for opening or closing the closure.

The first powered actuator 122 also includes a gearbox 140 configured to apply a force to the extensible member 134 for causing the extensible member 134 to move linearly. An adapter 142 is configured to mount the gearbox 140 to the closure or to the vehicle body 14. An electric motor 36 is coupled to the gearbox 140 for driving the first powered actuator 122. The electric motor 36 may be a standard DC motor such as a permanent magnet (e.g. ferrite) or a reluctance type motor. The electric motor 36 may be a brushless DC (BLDC) type motor such as a permanent magnet (e.g. ferrite) or a reluctance type motor. A closure member feedback sensor 64 in the form of a high-resolution position sensor 144 is disposed between the electric motor 36 and the gearbox 140. The high-resolution position sensor 144 may include a magnet wheel and a Hall effect sensor to provide speed, direction, and/or positional information regarding the extensible member 134 and the closure attached thereto. An electromagnetic (EM) brake 146 is coupled to the gearbox 140 on an opposite side from the electric motor 36. The EM brake 146 is optional and may not be included in all powered actuators. A cover 148 is attached to the gearbox 140 and is configured to enclose the extensible member 134. The cover 148 may help to prevent dust or dirt from fouling the extensible member 134 and/or to protect the extensible member 134 from contacting other components within the closure or the vehicle body 14. The cover 148 is formed as a hollow cylindrical tube, as shown on FIG. 7.

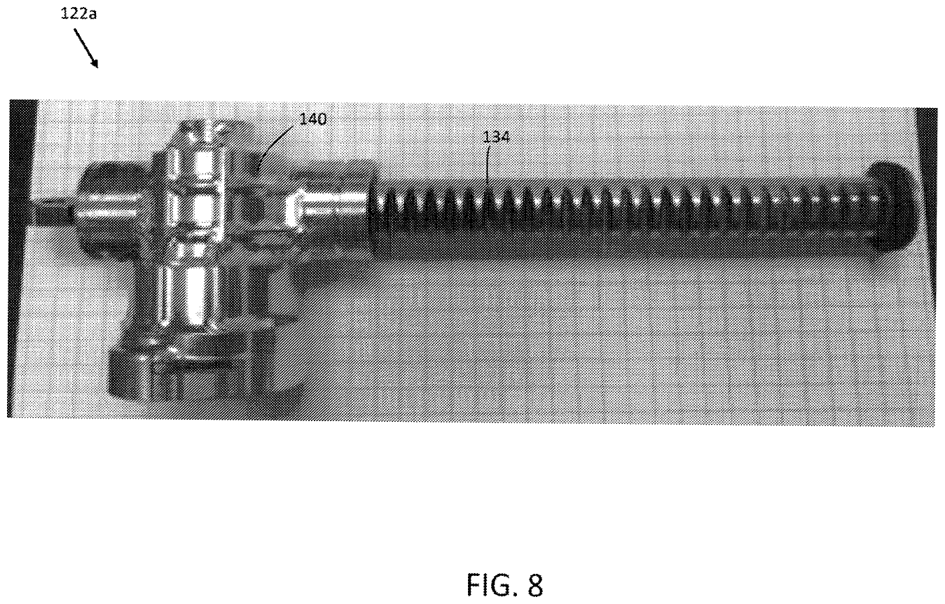

In some embodiments, and as shown in the first powered actuator 122 of FIG. 7, the extensible member 134 includes a leadscrew having one or more helical threads extending thereabout. The extensible member 134 may have other configurations. For example, FIG. 8 shows a second powered actuator 122a in which the extensible member 134 is configured as a rack gear that is configured to be driven linearly by a corresponding gear, such as a pinion gear (not shown) in the gearbox 140. In some embodiments, the gearbox 140 of the second powered actuator 122a may include a planetary gear drive with a rack and pinion output.

FIG. 9 shows another view of the first powered actuator 122 showing details of the adapter 142. As shown in FIG. 9, the adapter 142 has a generally tubular shape defining a central bore 150 for the extensible member 134 pass through. The adapter 142 includes a first flange 152 that is configured to be fixed to the gearbox 140 using a pair of screws or bolts. The adapter 142 also includes a second flange 154 that is configured to be fixed to the closure. Different adapters 142 having different configurations may be used to adapt powered actuators of the present disclosure to different vehicular applications, such as for different vehicles or for different closures within a same vehicle.

In some embodiments, the adapter 142 is configured to allow the first powered actuator 122 to be a direct replacement for a non-powered door check device 156 for limiting rotational travel of the closure, such as the door check device 156 shown in FIG. 10.

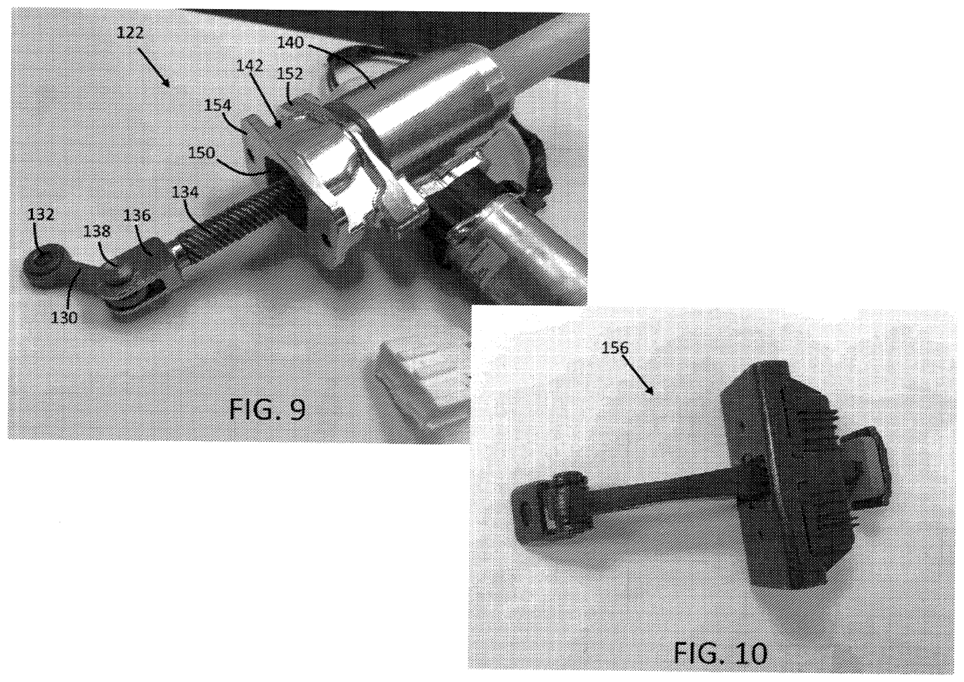

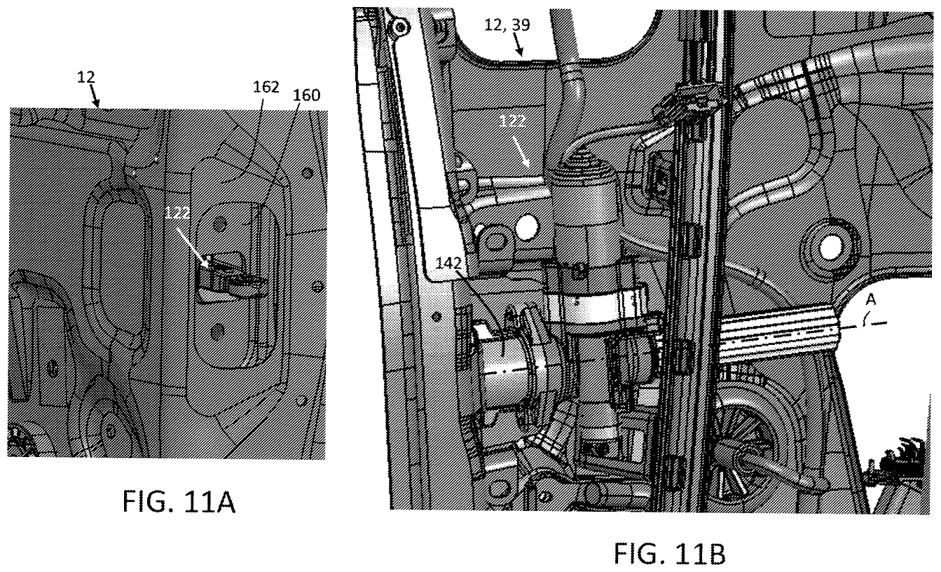

FIG. 11A illustrates the first powered actuator 122 protruding from an internal door cavity 39 of a front passenger door 12 according to aspects of the disclosure. The powered actuator 22, 122 of the present disclosure may be similarly within any vehicle closure, such as any swing door or a swing-type tailgate. Specifically, first powered actuator 122 is configured to mount to a preexisting mounting point 160 on the shut face 162 of the closure 12. The preexisting mounting point 160 is also configured to hold a door stopper, such as door check device 156 shown in FIG. 10.

FIG. 11B illustrates the powered actuator of FIG. 11A disposed within the internal cavity 39 of the passenger door 12. In some embodiments, the adapter 142 is configured to provide a rotational degree of freedom between the gearbox 140 and the shut face 162 of the closure for accommodating installation in a door cavity 39. For example, the powered actuator 122 may be rotated about a central axis A through the extensible member 134 and along which the extensible member 134 translates to open or close the door 12.

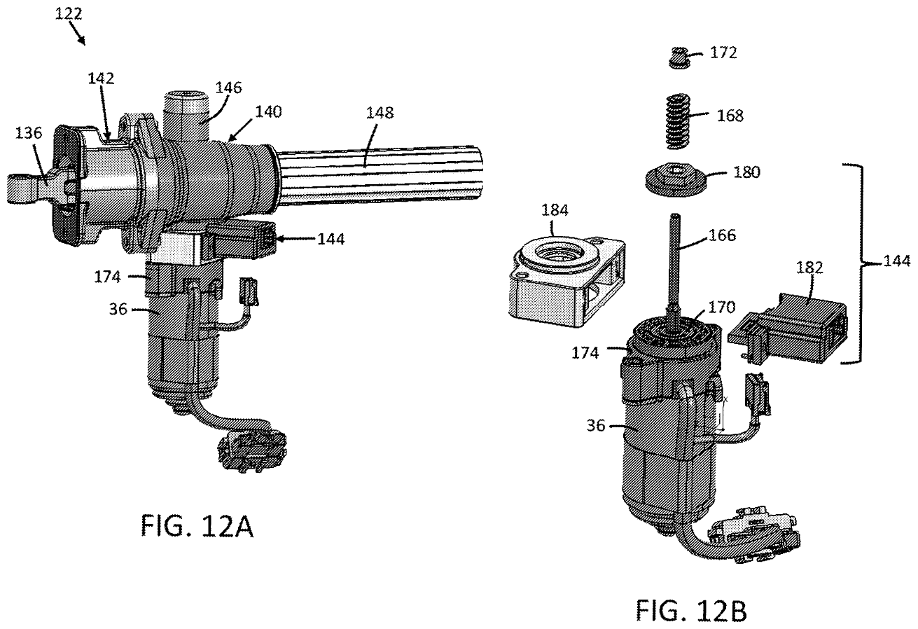

FIGS. 12A-12B illustrate the first powered actuator 122 according to aspects of the disclosure. Specifically, FIG. 12B shows the electric motor 36 configured to rotate a driven shaft 166 for turning a worm gear 168. The driven shaft 166 is supported by a proximal bearing 170 and a distal bearing 172. The proximal bearing 170 is supported within a motor bracket 174 that is attached to an axial end of the electric motor 36. The proximal bearing 170 is shown as a ball bearing and the distal bearing 172 is shown as a plain bearing or a bushing. However, either of the bearings 170, 172 may be a different type of bearing, such as a plain bearing, a ball bearing, a roller bearing, or a needle bearing. FIG. 12B also shows internal components of the high-resolution position sensor 144, including a magnet wheel 180 that is coupled to rotate with the driven shaft 166 and which includes a plurality of permanent magnets. The magnet wheel 180 shown in FIG. 12B has six permanent magnets, but the magnet wheel 180 may include any number of magnets. The high-resolution position sensor 144 also includes a Hall-effect sensor 182 configured to detect a movement of the permanent magnets in the magnet wheel 180 thereby and to generate an electrical signal in response to rotary movement of the magnet wheel 180. The high-resolution position sensor 144 also includes a sensor housing 184 enclosing the magnet wheel 180 and all or part of the Hall-effect sensor 182.

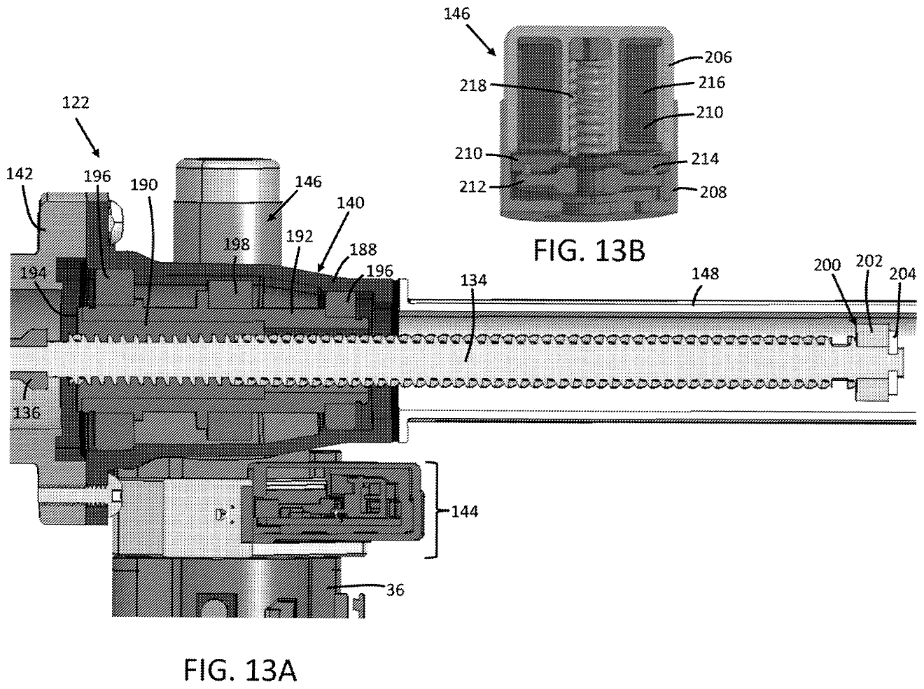

FIG. 13A illustrates a partial cut-away view of the first powered actuator 122 according to aspects of the disclosure. FIG. 13A shows the general arrangement of the gearbox 140, including a gearbox housing extending between the adapter 142 and the cover 148 and between the electric motor 36 and the EM brake 146, with the electric motor 36 and the EM brake 146 being aligned with one another and disposed perpendicular to the extensible member 134.

FIG. 13A also shows the internal details of the gearbox 140, including a lead nut 190 disposed around in threaded engagement with the extensible member 134 that is formed as a leadscrew. The leadscrew and lead nut configuration shown in FIG. 13A may provide a relatively low amount of backlash, thereby improving correlation between the detected position by the high-resolution position sensor 144 and the actual position of the closure. Such high precision detection may improve servo control of the powered actuator 22, 122. For example, the high-resolution sensor 144 signal may be configured to output at least 41 Hall counts per motor revolution for use by the servo control system, for example as shown in the table below illustrating a 5000 minimum Hall count for a 100 mm leadscrew travel:

| | Avg | | | | | Counts/ |
|---|---|---|---|---|---|---|
| Min | Travel | Lead | # of | Counts/ | Gear | Motor |
| Counts | (mm) | (mm) | Turns | turn | Ratio | Rev |
| 5000 | 100 | 18 | 5.56 | 900 | 22 | 41 |

The high-resolution sensor 144 signal may be configured to output other Hall counts per motor revolution for use by the servo control system. For example, the Hall count output may be greater than 2 Hall counts per motor revolution.

The lead nut 192 is fixed within a torque tube 192 having a tubular shape. Specifically the lead nut 192 includes a flanged end 194 that protrudes radially outwardly and engages an axial end of the torque tube 192 at an end adjacent to the adapter 142. The torque tube 192 is held within the gearbox housing 188 by a pair of tube supports 196, with each of the tube supports 196 disposed around the torque tube 192 at or near a corresponding axial end thereof. One or both of the tube supports 196 may include a bearing, such as a ball bearing or a roller bearing. A worm wheel gear 198 is disposed around the torque tube 192 between the tube supports 196 and is fixed to rotate therewith. The worm wheel gear 198 is in meshing engagement with the worm gear 168 (shown on FIG. 12B), thus causing the torque tube and the lead nut 190 to be rotated in response to the electric motor 36 driving the worm gear 168.

The first powered actuator 122 shown in FIG. 13A also includes a travel limiter 200 disposed on an axial end of the extensible member 134 opposite (i.e. farthest away from) the linkage 136. The travel limiter 200 is configured to engage a part of the gearbox 140, such as the torque tube 192 for limiting axial extension of the extensible member 134. Specifically, the travel limiter 200 includes a bumper 202 of resilient material, such as rubber, having a tubular shape extending around the extensible member 134 adjacent the axial end thereof. A retainer clip 204 holds the bumper 202 in place on the axial end of the extensible member 134. The retainer clip 204 may include any suitable hardware including, for example, a washer, a nut, a cotter pin, an E-Clip, or a C-clip such as a snap ring.

FIG. 13B illustrates cut-away view of the EM brake 146 of the powered actuator according to aspects of the disclosure. The EM brake 146 is coupled to the driven shaft 166 and configured to apply a braking force to oppose rotation of the driven shaft 166. Specifically, the EM brake 146 includes a cup-shaped inner housing 206 at least partially disposed within a cup-shaped outer housing 208. An armature plate 210 is fixed to rotate with the driven shaft 166, and a fixed plate 212 is fixed to the outer housing 208 and prevented from rotating. An annular band 214 of friction material is fixed to the armature plate 210 adjacent to the fixed plate 212. The EM brake 146 includes a solenoid coil 216 disposed within the inner housing 206 and configured to be energized by an electrical current for causing the armature plate 210 to move away from the fixed plate 212. A coil spring 218 extends through a central bore of the inner housing 206 and biases the armature plate 210 toward the fixed plate 212. A detailed description of the EM brake 146 and its operation are provided in applicant's U.S. Pat. No. 10,280,674, which is hereby incorporated by reference in its entirety.

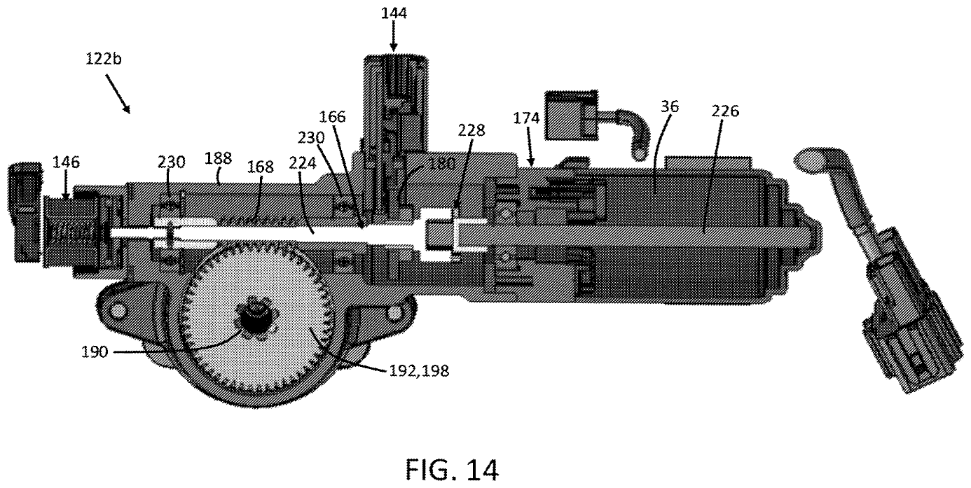

FIG. 14 illustrates a cut-away view of a third powered actuator 122b according to aspects of the disclosure. Specifically, the plane of the cut-away view shown in FIG. 14 extends through the driven shaft and a plane of the worm wheel 198. As shown in FIG. 14, the driven shaft 166 comprises a gearbox input shaft 224 that is coupled to a motor shaft 226 of the electric motor 36 via a coupling 228. The coupling 228 may be a fixed coupling, such as a splined connection, causing the gearbox input shaft 224 to rotate with the motor shaft 226. In some embodiments, the coupling 228 may be a flex coupling, allowing some degree of relative rotation between the gearbox input shaft 224 and the motor shaft 226. In some embodiments, the coupling 228 may include a clutch for selectively fixing the gearbox input shaft 224 to rotate with the motor shaft 226. A set of input bearings 230 holds the gearbox input shaft 224 on either side of the worm gear 168. Either or both of the input bearings 230 may be any type of bearing, such as a ball bearing, a roller bearing, etc.

In some embodiments, and as shown in FIG. 14, the torque tube 192 and the worm wheel 198 are formed as an integrated unit, with gear teeth formed on an outer perimeter, and with the lead nut 190 formed on an inner bore. In some embodiments, the torque tube 192 and the worm wheel 198 are formed as an integrated unit, and the lead nut 190 is a separate piece that is fixed to rotate therewith.

The third powered actuator 122b shown in FIG. 14 includes the EM brake 146 spaced away from the high-resolution position sensor 144, with the gearbox 140 disposed therebetween.

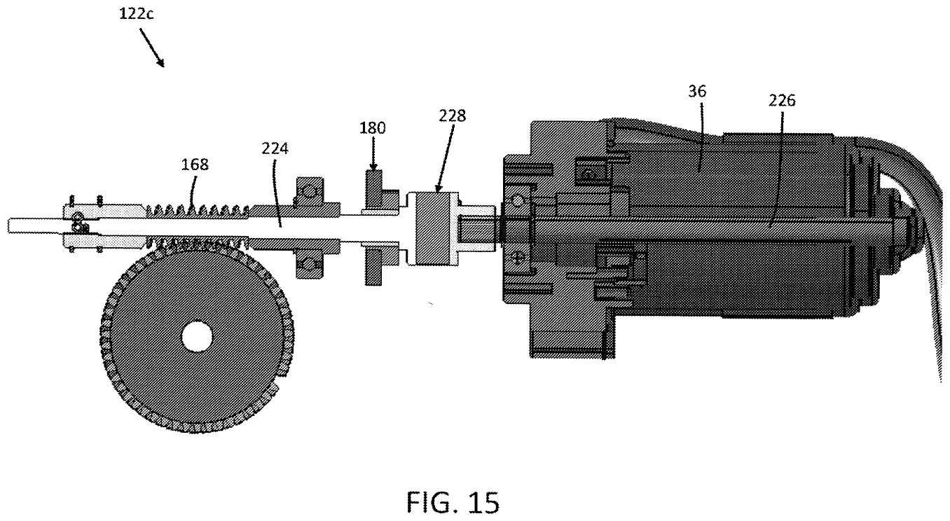

FIG. 15 illustrates a cut-away view of a fourth powered actuator 122c according to aspects of the disclosure. Specifically, the fourth powered actuator 122c is similar to the third powered actuator 122b shown in FIG. 14, in which the coupling 228 includes a clutch for selectively fixing the gearbox input shaft 224 to rotate with the motor shaft 226. In this case, the magnet wheel 180 is fixed to rotate with the gearbox input shaft 224, thus providing an indication of the extensible member 134 and the vehicle door coupled thereto.

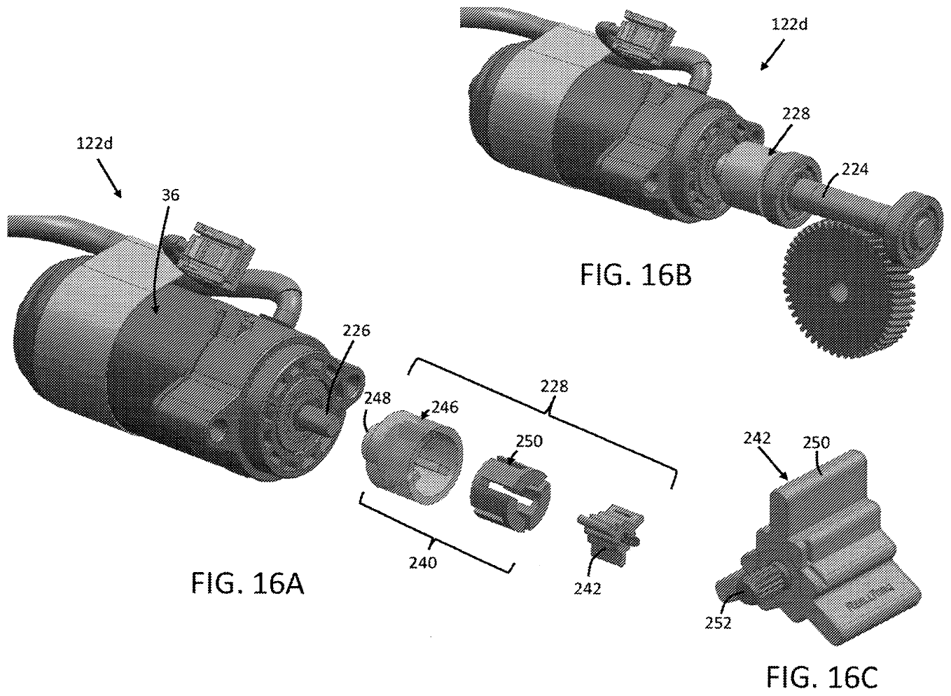

FIGS. 16A-16B show an electric motor 36 and coupling 228 of a fifth powered actuator 122d according to aspects of the disclosure. Specifically, FIG. 16A shows an exploded view of the coupling 228 which includes a flex coupling 240 and a slip device 242. The flex coupling 240 couples the motor shaft 226 of the electric motor 36 to the slip device 242 and allows some limited rotation therebetween. The flex coupling 240 may, for example, transmit driving torque from the motor shaft 226 to the slip device 242 while limiting the transmission of vibration therebetween. The flex coupling 240 shown in FIG. 16A includes an input member 246 having a cup-shape extending from a base 248 that is configured to rotate with the motor shaft 226. The base 248 may be keyed or splined or otherwise fixed to rotate with the motor shaft 226. The input member 246 is configured to turn the slip device 242, with an output member 250 of resilient material, such as rubber, disposed between the input member 246 and the slip device 242 for allowing some degree of rotation therebetween. As shown in FIG. 16C, the slip device 242 includes a triangular body 250 surrounding a shaft stub 252 that is splined and coupled to turn the gearbox input shaft 224. The slip device 242 is configured to provide some slip, or relative rotation between the input member 246 and the gearbox input shaft 224 if a torque therebetween exceeds a predetermined value.

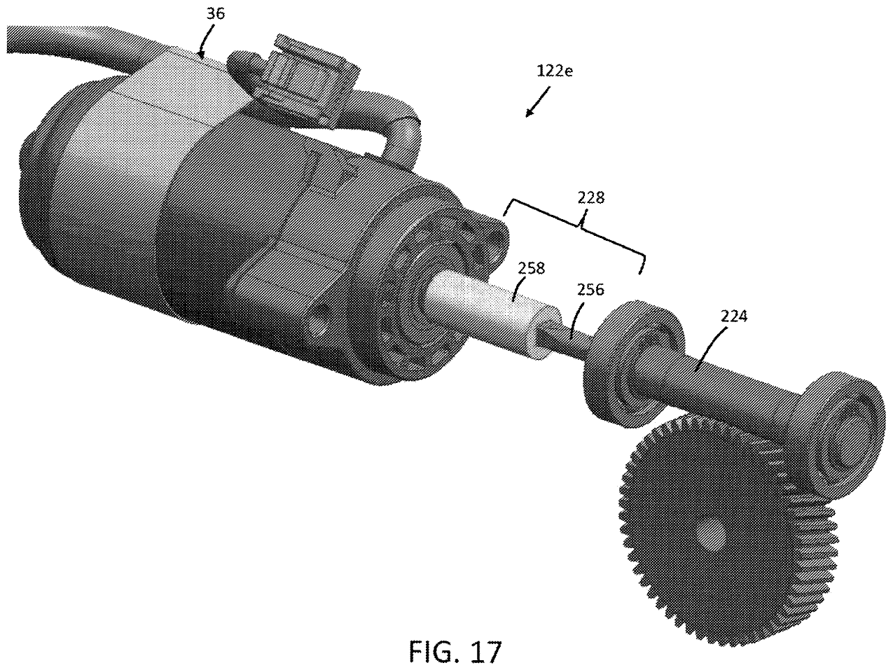

FIG. 17 shows an electric motor 36 and coupling 228 of a sixth powered actuator 122e according to aspects of the disclosure. Specifically, the coupling 228 shown in FIG. 17 includes a flex shaft 256 that is configured to twist by a predetermined amount in response to application of torque between two opposite ends thereof. One end of the flex shaft 256 is coupled to the gearbox input shaft 224, and the other end of the flex shaft 256 is coupled to the motor shaft 226 of the electric motor 36 via a shaft adapter 258. The shaft adapter 258 may be keyed or splined or otherwise fixed to rotate with the motor shaft 226. Thus, the flex shaft 256 provides for rotational flex between the motor shaft 226 and the gearbox input shaft 224.

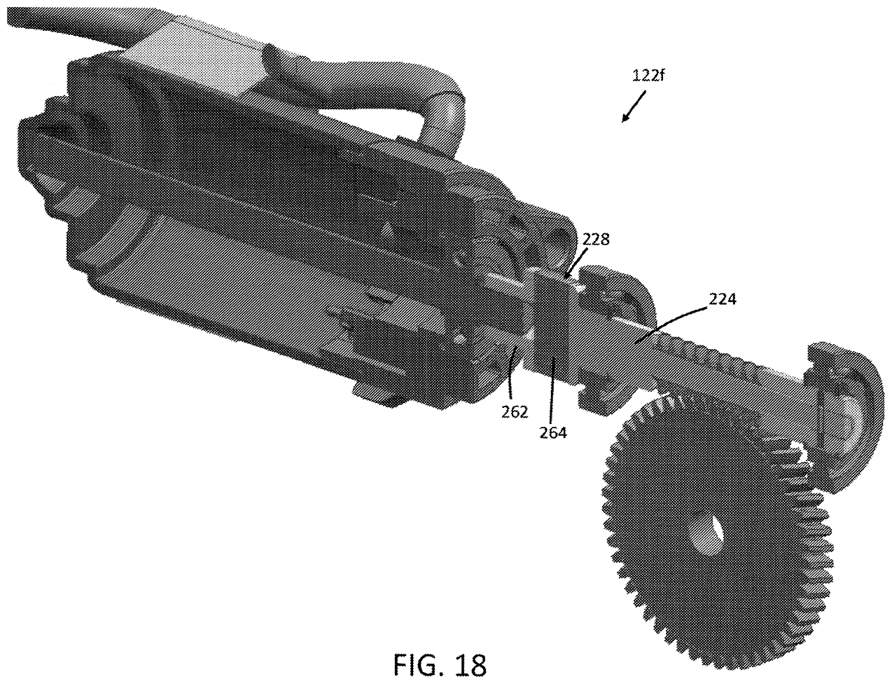

FIG. 18 shows an electric motor 36 and coupling 228 of a seventh powered actuator 122f according to aspects of the disclosure. Specifically, the coupling 228 shown in FIG. 18 is a flex coupling, which may be a high-speed flex coupling, which may be available off the shelf. The coupling 228 includes an input adapter 262 that is coupled to the motor shaft 226 of the electric motor 36. The input adapter 262 may be keyed or splined or otherwise fixed to rotate with the motor shaft 226. The coupling 228 also includes a resilient layer 264 of a resilient material, such as rubber, which is fixed to rotate with the input adapter 262 and which is also fixed to turn the gearbox input shaft 224. The coupling 228, thus functions as a flex coupling, allowing some limited relative rotation, less than one rotation, between the motor shaft 226 the gearbox input shaft 224. The seventh powered actuator 122f does not include any slip device and does not provide for any relative rotation between the motor shaft 226 the gearbox input shaft 224 beyond what is provided by the resilient layer 264 of the coupling 228.

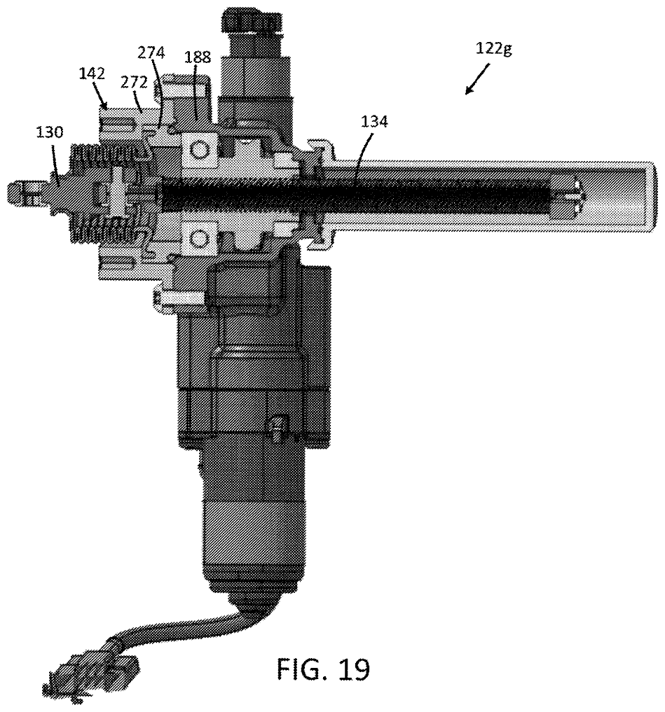

FIG. 19 shows an eighth powered actuator 122g according to aspects of the disclosure. The eighth powered actuator 122g may be similar or identical to other powered actuators disclosed herein, but with some additional protective equipment. Specifically, a boot 270 is configured to cover the extensible member 134 and to move with the extensible member 134 extends out of the adapter 142. The boot 270 may have a tubular and ribbed construction, similar to a covering of a shock absorber, to prevent contaminants from contacting the extensible member 134. The boot 270 may also prevent wires or other items from being caught in the extensible member 134 as it extends or retracts from the adapter 142. One end of the boot 270 is fixed to the link bar 130, and the other end of the boot 270 is fixed to the adapter 142. In some embodiments, and as shown in FIG. 19, the adapter is a two-piece design, including an outer member 272 receiving and surrounding an inner member 274, with the boot 270 sandwiched therebetween. The inner and outer members 272, 274 may be held together by the screws or bolts that hold the adapter 142 to the gearbox housing 188.

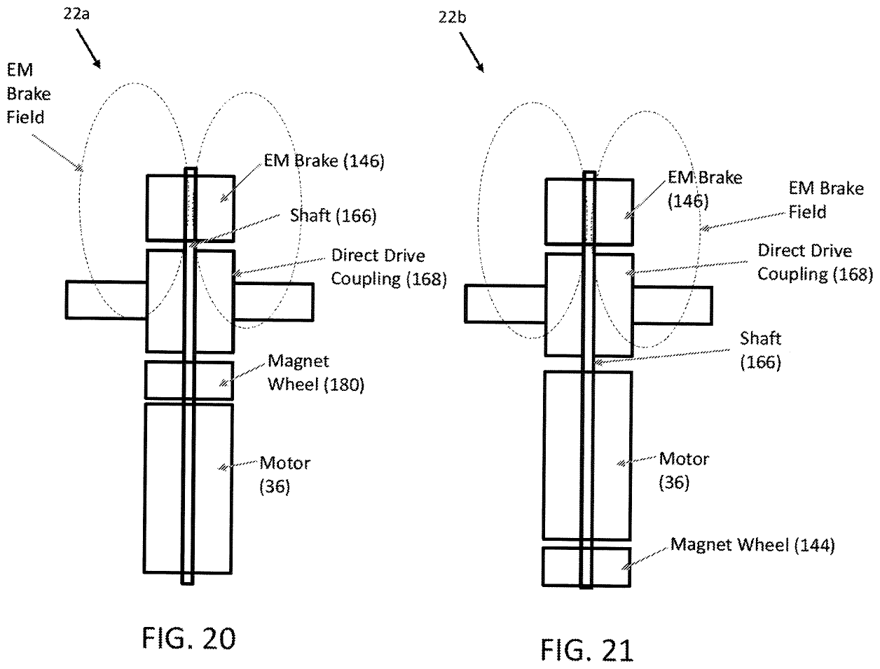

FIG. 20 illustrates a schematic block diagram of components within a powered actuator having a first configuration 22a according to aspects of the disclosure. Specifically, FIG. 20 shows the magnet wheel 180 being spaced apart from the EM brake 146 by a direct drive coupling (e.g. the worm gear 168), thus reducing or eliminating electromagnetic interference (i.e. the EM Brake Field) from interfering with the high-resolution position sensor. More specifically, the first configuration 22a includes the EM brake 146, the direct drive coupling (168), the magnet wheel 180, and the electric motor 36 are all disposed along the driven shaft 166 in that given order.

FIG. 21 illustrates a schematic block diagram of components within a powered actuator having a second configuration 22b according to aspects of the disclosure. Specifically, FIG. 21 shows the magnet wheel 180 being spaced apart from the EM brake 146 by the electric motor 36 and the direct drive coupling (e.g. the worm gear 168), thus reducing or eliminating electromagnetic interference from interfering with the high-resolution position sensor. More specifically, the second configuration 22b includes the EM brake 146, the direct drive coupling (168), the electric motor 36, and the magnet wheel 180 all disposed along the driven shaft 166 in that given order.

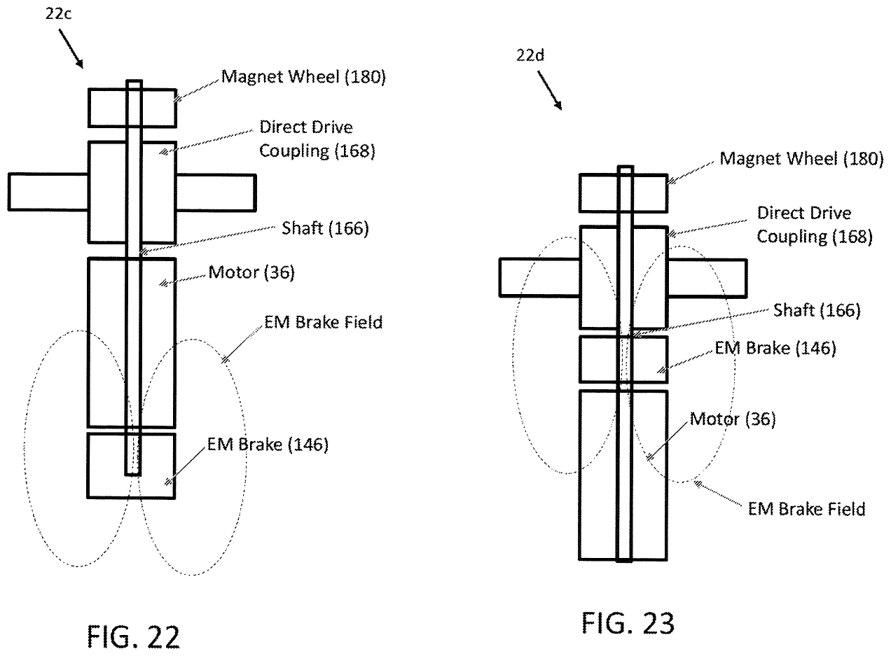

FIG. 22 illustrates a schematic block diagram of components within a powered actuator having a third configuration 22c according to aspects of the disclosure. Specifically, FIG. 22 shows the magnet wheel 180 being spaced apart from the EM brake 146 by the electric motor 36 and the direct drive coupling (e.g. the worm gear 168), thus reducing or eliminating electromagnetic interference from interfering with the high-resolution position sensor. More specifically, the third configuration 22c includes the magnet wheel 180, the direct drive coupling (168), the electric motor 36, and the EM brake 146 all disposed along the driven shaft 166 in that given order.

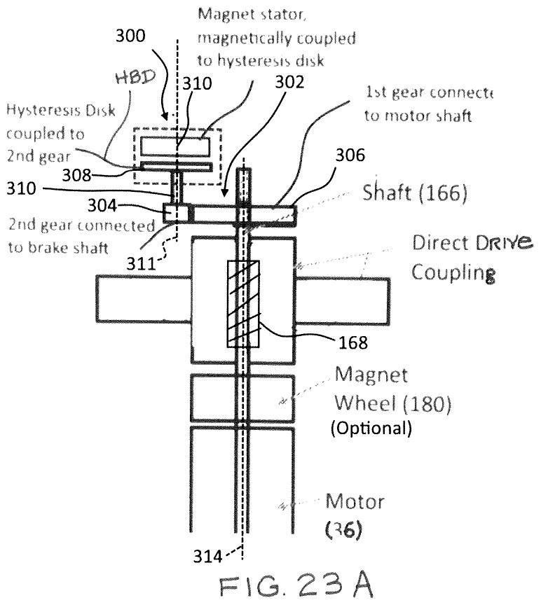

FIG. 23 illustrates a schematic block diagram of components within a powered actuator in a fourth configuration 22d according to aspects of the disclosure. Specifically, FIG. 23 shows the magnet wheel 180 being spaced apart from the EM brake 146 by the direct drive coupling (e.g. the worm gear 168), thus reducing or eliminating electromagnetic interference from interfering with the high-resolution position sensor. More specifically, the fourth configuration 22d includes the magnet wheel 180, the direct drive coupling 168, the EM brake 146, and the electric motor 36 all disposed along the driven shaft 166 in that given order.

FIG. 23A illustrates a schematic block diagram of components within a powered actuator in a fifth configuration according to aspects of the disclosure. Specifically, FIG. 23A shows a portion as a replacement of a brake mechanism 300, such as for example the EM brake, coupled to the motor shaft 166 with a magnetic non-electric brake device such as a hysteresis brake device HBD. The brake mechanism 300 is illustratively coupled to the motor drive shaft 166 to apply a braking force on the driven shaft 166. This brake 300 can provide the hold open force when the motor 36 is stopped. Since it is upstream of the nut tube gearing, there will be an increase in torque multiplication for increased holding force with a smaller magnet and packaging size of the brake mechanism 300. To further increase the holding force, and/or reduce the magnet brake size, there is further gear reduction 302 connected to the motor shaft 166. The brake mechanism 300 may thus be indirectly coupled to the driven shaft 166 via the gear reduction mechanism 302. This provides a non-powered brake that has no friction/contacting components, that also is small, with reduced cost since the magnet size is reduced using additional gearing off the motor shaft. The brake mechanism 300 is illustratively non-electric meaning no power or current is required to be supplied to the brake mechanism 300 to generate a braking force to the driven shaft 166. The gear reduction mechanism 300 is shown as including a pair 304, 306 of meshed gears, but may also be configured as other types of a gear couplings, a toothed belt coupling, or a belt coupling for example. The gear reduction mechanism 300 is configured to multiply a braking force of the brake mechanism applied to the driven shaft 166 such as by configuring the gear 306 connected to the drive shaft 166 to be larger than the gear 304. Illustratively brake mechanism 300 comprises a hysteresis disk 308 configured to rotate about a brake axis 311. The rotor, as the hysteresis brake, 308 is connected to a brake shaft 310 to which the gear 304 is mounted. The rotor 308 is adapted to rotate when the gear 304 is rotated by gear 306 relative to a stator 310 as a magnetic stator to generate the braking force to resist the rotation of the shaft 166. In the example configuration as shown in FIG. 23A, the brake axis 311 is show as parallel to the driven shaft 166 axis 314. As shown in FIG. 23A, the brake axis 311 is show as being adjacent to the driven shaft 166 axis 314. While the brake mechanism 300 has been shown to be illustratively coupled to the driven shaft 166, the brake mechanism 300 may be coupled through the torque multiplication mechanism 302 to other rotary components, such as to a lead screw of commonly owned U.S. patent application Ser. No. 18/593,855 titled “POWERED SWING DOOR ACTUATOR WITH SWING LINKAGE MECHANISMS”, the entire contents of which are incorporated herein by reference, for example. Torque multiplication mechanism 302 is adapted to multiply the brake force of the brake mechanism such that a smaller more compact brake mechanism 300 may be provided.

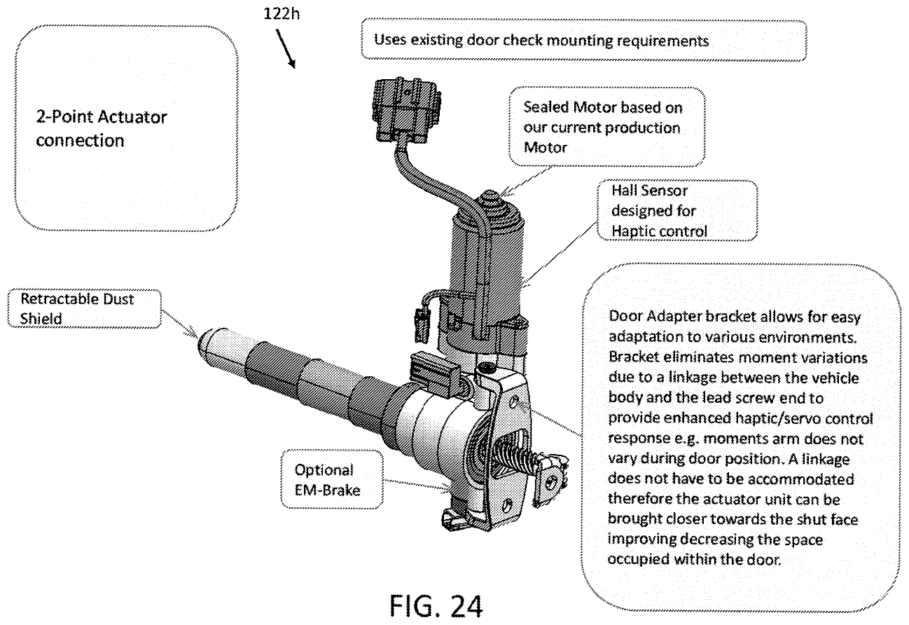

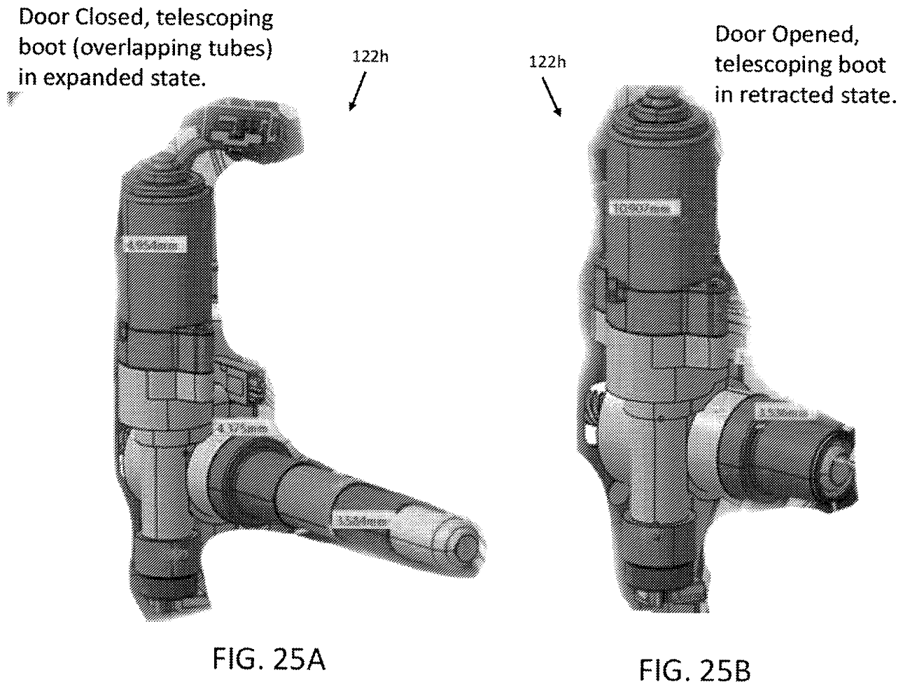

FIGS. 24, and 25A-25B illustrate a ninth powered actuator 122h according to aspects of the disclosure. Specifically, the ninth powered actuator includes a retractable dust shield enclosing the extensible member 134. The retractable dust shield has a telescopic design including a plurality of tubular segments configured to move between an expanded state shown in FIG. 25A and a retracted state shown in FIG. 25B.

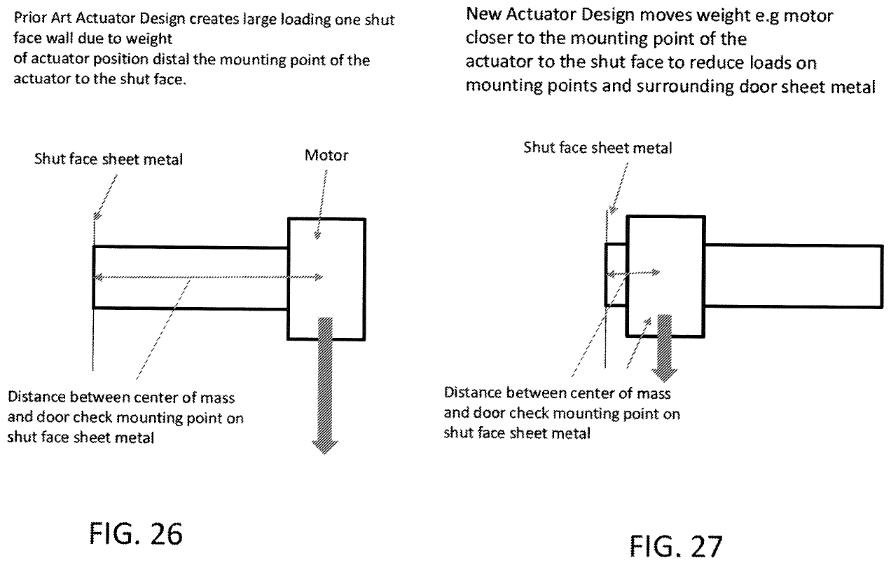

FIG. 26 illustrates a schematic block diagram of components within a powered actuator of the prior art, and FIG. 27 illustrates a schematic block diagram of components within a powered actuator according to aspects of the disclosure.

Specifically, FIG. 27 illustrates the powered actuator designs of the present disclosure that moves weight (e.g. the motor) closer to the mounting point of the actuator to the shut face when compared with powered actuator designs of the prior art. The powered actuator designs of the present disclosure may, thus, reduce loads on mounting points and surrounding door sheet metal.

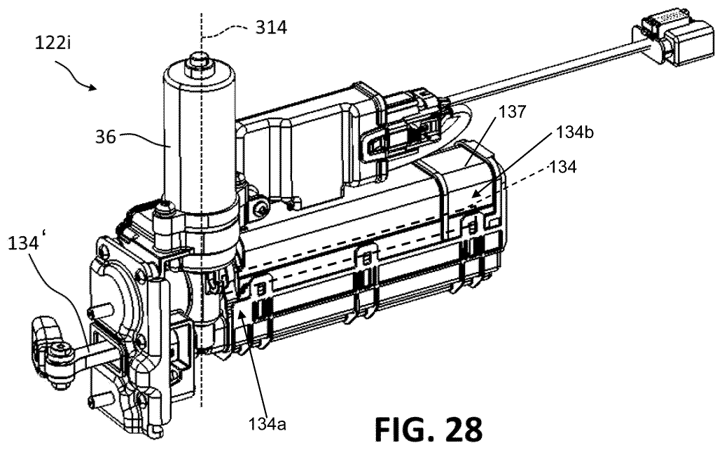

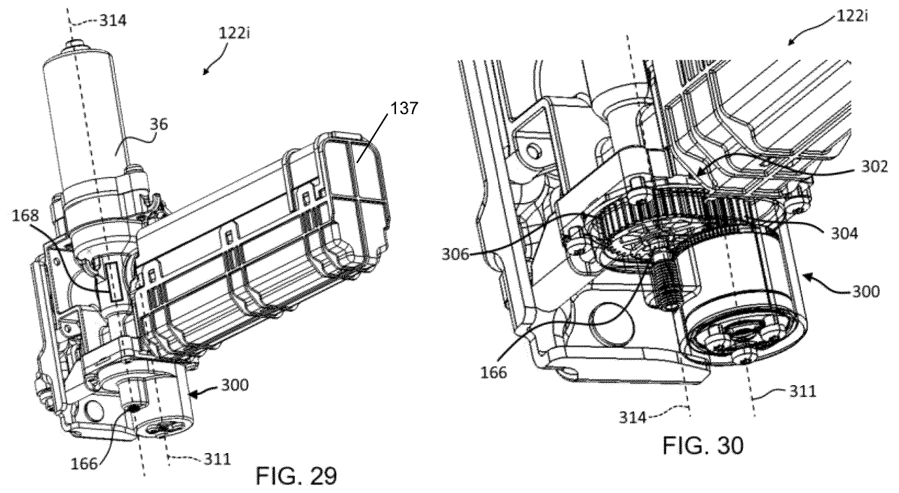

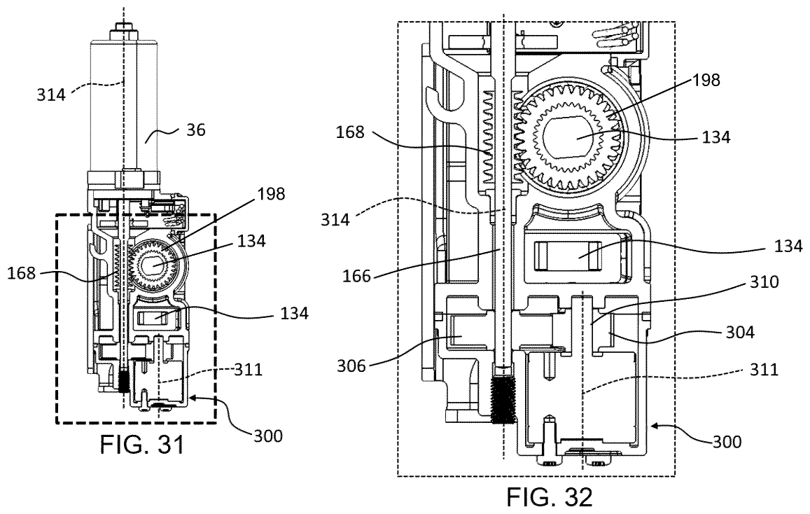

With now further reference to FIGS. 28 to 34, in addition to FIG. 23A, illustrate a tenth powered actuator 122i according to aspects of the disclosure. Specifically, the tenth powered actuator includes a retractable extensible member 134′ as a linkage and a stationary/rotatable lead screw 134 to translate a nut assembly 135 to which the linkage 134′ is connected as described in more details in US published patent US2024/0301741 titled “Powered Swing Door Actuator with Swing Linkage Mechanisms”, the entire contents of which are incorporated herein by reference in its entirety. The brake mechanism 300 is shown operatively coupled to the motor shaft 166 at a position below the motor 36 and below the worm gear 168. Optionally, the axis 311 of the brake mechanism 30 is illustrated as being parallel to, non-concentric to, and adjacently offset from the motor shaft axis 314. In accordance with other possible configurations of brake mechanism 300, a friction brake, a drag brake maybe provided instead of a magnetic brake (permanent magnetic brake, hysteresis brake) coupled to the motor axis 166 via a torque multiplication configuration, such as for example a belt or toothed coupling to connect the two shafts 166, 310 or via a spur/helical gear stage.

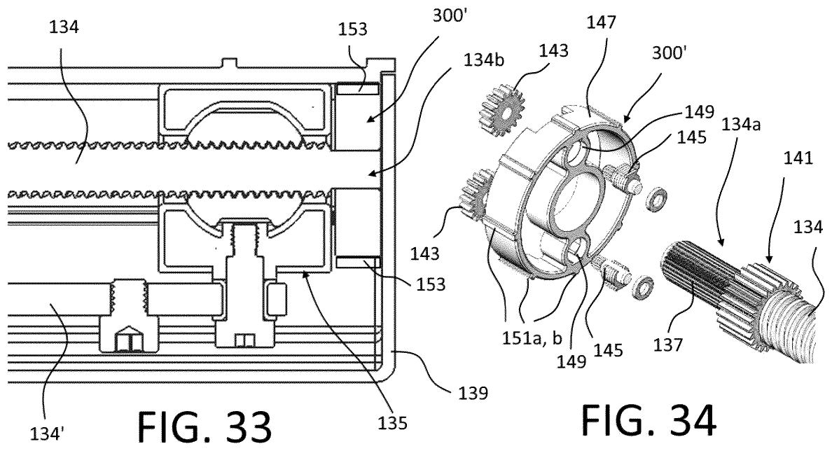

Now referring to FIG. 33 and FIG. 34, the brake mechanism 300 of powered actuator 122i may be substituted or complimented with a brake mechanism 300′ configured to act against a rotation of a rotating shaft, such as leadscrew 134. The brake mechanism 300′ may be coupled to a proximal end 134a or a distal 135b end of the lead screw 134. Proximal end 134a is illustrated as having splines 137 for fixed connect to the gear 198 rotated by the worm 168 while distal end 134b may optionally be supported by an actuator housing 139 also enclosing the lead screw 134. A toothed circumference 141 at the proximal end 134a of the lead screw 134 may be provided for geared interaction with a pair of gears 143 for providing torque reduction. Gears 143 are rotatably supported by pin posts 145 secured to a brake rotor 147 via mounting apertures 149 formed in the brake rotor 147. Rotation of the lead screw 134 thus causes rotation of the rotor 147 via the actuation of the gearing 141, 143. Rotor 147 may provide resistance to rotation of the lead screw 134. For example, rotor may be configured as a mechanical brake (“drag brake” type) via interaction of friction members 151a circumferentially disposed on the rotor 147 for contact with the housing 139 or other stator component 153. Friction generated through the contact of the stator component 153 and the friction members 151 is multiplied via the gearing 141, 143, or by direct coupling with the lead screw as shown in FIG. 33, prior to resistance being applied to the lead screw 134. Constant, smooth, quiet, thermally stable friction for improved mechatronic stability. Alternatively, magnetic members 151b may be provided to provide magnetic braking. Brake device 300′ is shown to be applied indirectly to the motor shaft 168 and to a rotational component perpendicular to the axis 314.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure provides a number of example embodiments of vehicle exterior components that are configured to hold one or more parts of a radar sensor, and which addresses the constraints of limited space and management of heat that is generated by operation of the radar sensor. In some embodiments, the radar sensor includes parts having a maximum operating temperature of 125 degrees C. at an ambient temperature of 80 degrees C. The present disclosure also provides example embodiments that provide water resistance to prevent the radar sensor from being adversely affected by exposure to moisture.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A powered actuator for a closure of a vehicle, comprising:
an electric motor configured to rotate a driven shaft;
an extensible member configured to be coupled to one of a body or the closure of the vehicle for opening or closing the closure;
a gear reduction mechanism configured to apply a force to the extensible member for causing the extensible member to extend and retract in response to rotation of the driven shaft; and
a brake mechanism coupled to the motor drive shaft to apply a braking force on the driven shaft.

2. The powered actuator of claim 1, wherein the brake mechanism is indirectly coupled to the driven shaft.

3. The powered actuator of claim 2, wherein the brake mechanism is coupled to the driven shaft using a gear reduction mechanism.

4. The power actuator of claim 3, wherein the gear reduction mechanism is selected from the group consisting of: a gear coupling, a toothed belt coupling, and a belt coupling.

5. The powered actuator of claim 3, wherein the gear reduction mechanism is configured to multiply a braking force of the brake mechanism applied to the driven shaft.

6. The powered actuator of claim 1, wherein the brake mechanism is coupled to the driven shaft using a gear reduction mechanism.

7. The powered actuator of claim 6, wherein the brake mechanism comprises a magnetic brake.

8. The powered actuator of claim 7, wherein the magnetic brake is a hysteresis brake having a stationary component and a rotatable component.

9. The powered actuator of claim 1, wherein the driven shaft is configured to extend along a driven shaft axis and the brake mechanism comprises a brake axis disposed parallel and adjacent to the driven shaft axis.

10. The powered actuator of claim 1, wherein the driven shaft comprises a first gear, and the brake mechanism comprises a brake shaft supporting a second gear, wherein the first gear is in meshed engagement with the second gear.

11. The powered actuator of claim 10 wherein the driven shaft is configured to support a worm gear, the worm gear configured to rotate a worm wheel, the worm wheel configured to move the extensible member.

12. The powered actuator of claim 11, wherein the worm gear is positioned between the first gear and the electric motor.

13. The powered actuator of claim 11, wherein the extensible member comprises a leadscrew configured to move axially in response to rotation of a lead nut, and wherein the worm wheel is coupled to rotate the lead nut.

14. The powered actuator of claim 1, wherein the extensible member comprises linkage coupled to a lead nut moveable in response to rotation of a lead screw, the extensible member configured to move axially in response to rotation of the lead nut, and wherein the driven shaft is adapted to rotate the lead screw.

15. A powered actuator for a closure of a vehicle comprising:
an electric motor configured to rotate a driven shaft;
a worm coupled to the driven shaft;
a gear coupled to the worm;
an extensible member coupled to the gear, the extensible member configured to be coupled to one of a body or the closure of the vehicle for opening or closing the closure, wherein the extensible member is configured to extend and retract in response to rotation of the gear;
a brake mechanism coupled to the driven shaft, the brake mechanism having a hysteresis magnet; and
a gear reduction mechanism operatively coupling the driven shaft to the brake mechanism;
wherein the brake mechanism comprises a brake axis that is disposed parallel to an axis of the driven shaft.

16. A method of braking a powered actuator for a closure of a vehicle comprising an electric motor configured to rotate a driven shaft to extend and retract an extensible member, the method comprising:
providing a brake mechanism;
coupling the brake mechanism to the driven shaft using a gear reduction mechanism; and
configuring the torque multiplication mechanism to multiply the brake force of the brake mechanism to be applied by the gear reduction mechanism to the driven shaft.

17. The method of claim 16, further comprising arranging an axis of the brake mechanism to be parallel with the axis of the driven shaft.

18. The method of claim 17, further comprising providing the gear reduction mechanism having meshed gears.

19. The method of claim 18, further comprising configuring the brake mechanism having a hysteresis magnet.

20. The method of claim 18, further comprising configuring the brake mechanism having a stator and a rotor, the rotor coupled to the gear reduction mechanism.
